(19) United States
(12) Patent Application Publication
(10) Pub. No.: US 2011/0260972 A1
(43) Pub. Date: Oct. 27, 2011

(54) ACCOMMODATING DEVICE FOR RECEIVING A CONNECTOR OF A REEL-TYPE MOUSE

(76) Inventor: Hsu-Jui HUANG, Taipei City (TW)

(21) Appl. No.: 13/092,358

(22) Filed: Apr. 22, 2011

(30) Foreign Application Priority Data
Apr. 22, 2010 (TW) 099207377

(51) Int. Cl. G06F 3/033

(52) U.S. Cl. 345/163

(57) ABSTRACT

An accommodating device for receiving a connector of a reel-type mouse includes a mouse body, a reel unit, and an accommodating portion. The mouse body includes an operating surface, a bottom surface, an accommodating space, and an opening. The accommodating space is between the operating surface and the bottom surface. The operating surface has at least one button body. The reel unit is in the accommodating space, and has a cable and a cable connector. The cable is movable via the opening for linear displacement motion. The cable connector is connected to an end of the cable, and is outside the accommodating space. The accommodating portion is disposed on the bottom surface. An appearance of the accommodating portion corresponds to that of the cable connector so as to receive the cable connector.

### BACKGROUND OF THE INVENTION

1. Field of the Invention

The present invention relates to an accommodating device for receiving a connector, more particularly to an accommodating device for receiving a connector of a reel-type mouse.

2. Description of the Related Art

Nowadays, in the computer era, the overall performance of computers is increasingly improved, and the convenience of the peripherals, such as a computer mouse, a keyboard, an auxiliary tool, and so on, also attracts more attention. The computer mouse is a necessary device . When we are using a computer, the mouse lets us operate the computer easily to draw and implement data processing. When the mouse is connected to the computer, the transmission line of the mouse is inserted into the connecting port of the computer such that the displacement coordinates of the mouse can be inputted to the computer.

When the mouse is moved by a user, due to the length issue (too long or too short) of the transmission line, it often impedes the use of the mouse. Besides, when the mouse is not in use, the transmission line is often wound on the mouse or the transmission line and mouse are tied together with string. However, these two methods easily cause the damage to the internal structure of the transmission line, i.e., break or pull off. Consequently, bad connection, contact problems or bad line may occur frequently.

Therefore, in commercial, a mouse having a reel inside has been developed for retracting the transmission line of the mouse. However, even so, the connector (USB connector are widely used) is still left outside the mouse, which not only occupies space but also leads to bent or broken connectors easily. Thus, it is necessary to propose an invention to resolve this issue.

### SUMMARY OF THE INVENTION

Therefore, the object of the present invention is to provide an accommodating device for receiving a connector of a reel-type mouse, when the mouse is not in use.

Accordingly, an accommodating device of the present invention is adapted for receiving a connector of a reel-type mouse. The accommodating device comprises a mouse body, a reel unit, and an accommodating portion.

The mouse body includes an operating surface, a bottom surface, an accommodating space, and an opening. The accommodating space is between the operating surface and the bottom surface. The operating surface has at least one button body.

The reel unit is in the accommodating space, and has a cable and a cable connector. The cable is movable via the opening for linear displacement motion. The cable connector is connected to an end of the cable, and is outside the accommodating space.

The accommodating portion is disposed on the bottom surface. An appearance of the accommodating portion corresponds to that of the cable connector so as to receive the cable connector.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of an accommodating device according to a preferred embodiment of the present invention, illustrating a cable connector is pulled out for use;

FIG. 2 is a perspective view of the accommodating device according to the preferred embodiment of the present invention, illustrating a cable is winding back on a reel unit; and

FIG. 3 is a bottom view of the accommodating device in the preferred embodiment, illustrating the cable connector is received in an accommodating portion.

### DETAILED DESCRIPTION OF THE PREFERRED EMBODIMENT

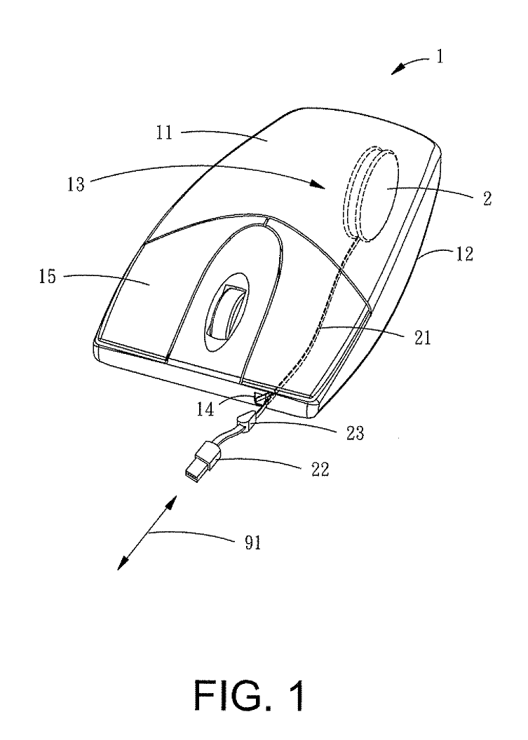

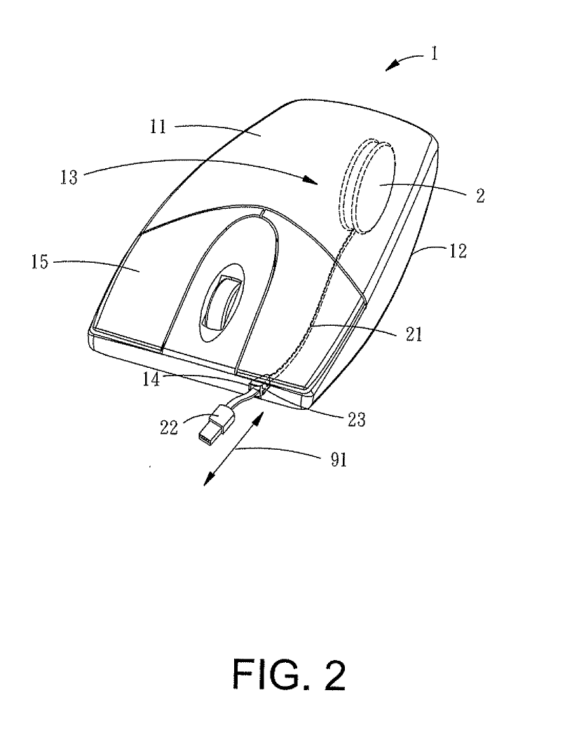

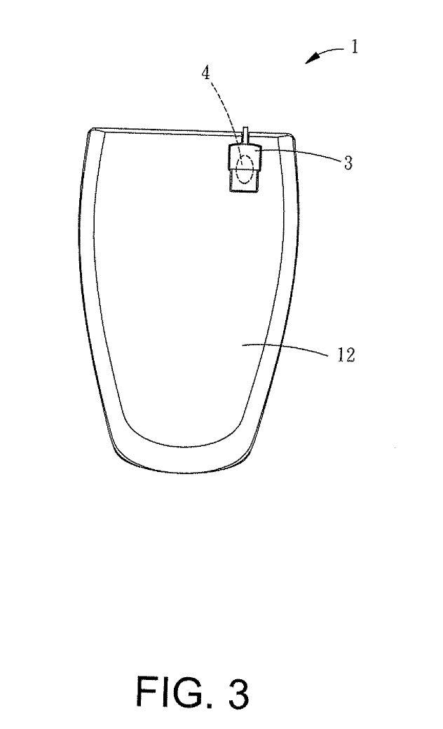

Referring to FIGS. 1, 2 and 3, a preferred embodiment of an accommodating device of the present invention is adapted for receiving a connector of a reel-type mouse. The accommodating device includes a mouse body 1, a reel unit 2, and an accommodating portion 3. The mouse body 1 includes an operating surface 11, a bottom surface 12, an accommodating space 13, and an opening 14. The accommodating space 13 is between the operating surface 11 and the bottom surface 12. The operating surface 11 has at least one button body 15 for a user (not shown) to press on. The bottom surface 12 is movable on a plane.

The reel unit 2 is located in the accommodating space 13, and has a cable 21 and a cable connector 22. The cable 21 has a flat cable structure. The cable connector 22 can be designed as a USB connector, which has a flat cuboid structure . The cable 21 is connected to the cable connector 22 via an abutting connector 23 such that a part of the cable 21, between the abutting connector 23 and the cable connector 22, forms a stair-like portion. Therefore, extending directions of the cable 21 and the cable connector 22 can be regarded as parallel to each other. Due to external force, the cable 21 is movable via the opening 14 for linear displacement motion 91. The cable connector 22 is connected to an end of the cable 21, and is outside the accommodating space 13. When the cable 21 is retracted, the abutting connector 23 can abut against the opening 14 such that the cable connector 22 is left outside the accommodating space 13.

The accommodating portion 3 is disposed on the bottom surface 12. An appearance of the accommodating portion 3 corresponds to that of the cable connector 22 so as to receive the cable connector 22. In this preferred embodiment, since the cable connector 22 is a USB connector, the cable connector 22 is made of metal. The accommodating device of the present invention further includes an attracting portion 4. The attracting portion 4 is located in the accommodating space 13, is attached on the bottom surface 12, and corresponds to the accommodating portion 3. When the cable 21 is retracted on the reel unit 2 and the abutting connector 23 abuts against the opening 14, the attracting portion 4 includes a magnet such that attracting portion 4 attracts the cable connector 22 in the accommodating portion 3.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An accommodating device for receiving a connector of a reel-type mouse, comprising:
a mouse body including an operating surface, a bottom. surface, an accommodating space, and an opening, the accommodating space being between the operating surface and the bottom surface, the operating surface having at least one button body;
a reel unit being in the accommodating space and having a cable and a cable connector, the cable being movable via the opening for linear displacement motion, the cable connector being connected to an end of the cable and being outside the accommodating space; and
an accommodating portion disposed on the bottom surface, an appearance of the accommodating portion being corresponding to that of the cable connector so as to receive the cable connector.

2. The accommodating device as claimed in claim 7. , wherein the cable connector is a USB connector.

3. The accommodating device as claimed in claim 1, wherein the cable connector is made of metal.

4. The accommodating device as claimed in claim 1, wherein the accommodating device further comprises an attracting portion that is located in the accommodating space, is attached on the bottom surface, and corresponds to the accommodating portion.

5. The accommodating device as claimed in claim 4, wherein the attracting portion includes a magnet.
